(19) United States
(12) Patent Application Publication
(10) Pub. No.: US 2020/0232337 A1
(43) Pub. Date: Jul. 23, 2020

(54) SEAL STRUCTURE FOR TURBOCHARGER

(71) Applicant: IHI Corporation, Koto-ku (JP)

(72) Inventors: Katsunori HAYASHI, Tokyo (JP); Satoshi SHIMODA, Tokyo (JP); Yuuji KOBAYASHI, Tokyo (JP); Takafumi UEDA, Tokyo (JP)

(73) Assignee: IHI Corporation, Koto-ku (JP)

(21) Appl. No.: 16/837,088

(22) Filed: Apr. 1, 2020

Related U.S. Application Data
(63) Continuation of application No. PCT/JP2018/036031, filed on Sep. 27, 2018.

(30) Foreign Application Priority Data
Oct. 16, 2017 (JP) 2017-199988

(51) Int. Cl. F01D 11/00; F02B 37/24; F01D 17/16

(52) U.S. Cl. CPC F01D 11/003; F02B 37/24; F01D 17/165; F05D 2300/509; F05D 2240/14; F05D 2240/55; F05D 2300/611; F05D 2220/40

(57) ABSTRACT

A seal structure for a turbocharger, including: a seal ring; a seal groove in which the seal ring is disposed; and a treated portion, which is formed at least at a part of one or both of the seal ring and the seal groove, and is subjected to surface treatment for anti-oxidation.

### CROSS REFERENCE TO RELATED APPLICATIONS

This application is a continuation application of International Application No. PCT/JP2018/036031, filed on Sep. 27, 2018, which claims priority to Japanese Patent Application No. 2017-199988, filed on Oct. 16, 2017, the entire contents of which are incorporated by reference herein.

### BACKGROUND ART

### Technical Field

The present disclosure relates to a seal structure for a turbocharger in which a seal ring is disposed in a seal groove. This application claims the benefit of priority to Japanese Patent Application No. 2017-199988 filed on Oct. 16, 2017, and contents thereof are incorporated herein.

### Related Art

Hitherto, there has been widely used a variable capacity turbocharger. In this turbocharger, for example, as disclosed in Patent Literature 1, a plurality of nozzle vanes are arranged in a flow passage for exhaust gas. An angle of each nozzle vane changes in the flow passage to change a flow passage width (so-called “nozzle throat width”). In such a manner, a flow rate of the exhaust gas which flows through the flow passage is controlled. Moreover, in Patent literature 1, there is disclosed an example of a configuration in which the nozzle vanes are disposed between a first nozzle plate and a second nozzle plate which are provided separately from a turbine housing. A seal ring is disposed between the first nozzle plate and the turbine housing and between the second nozzle plate and the turbine housing.

### CITATION LIST

### Patent Literature

Patent Literature 1: JP 2009-180111 A

### SUMMARY

### Technical Problem

For example, as described in Patent Literature 1, the seal ring provided to the turbocharger is pressurized toward a radially inner side or a radially outer side. When a member in contact with the seal ring in the radial direction is thermally expanded, the seal ring follows the thermal expansion to deform. However, when the seal groove in which the seal ring is disposed is expanded by oxidation, the deformation of the seal ring in the radial direction is hindered. As a result, sealability is degraded.

An object of the present disclosure is to provide a seal structure for a turbocharger, which is capable of suppressing degradation in sealability of a seal ring.

### Solution to Problem

In order to solve the above-mentioned problem, according to one mode of the present disclosure, there is provided a seal structure for a turbocharger, including: a seal ring; a seal groove in which the seal ring is disposed; and a treated portion, which is formed at least at a part of one or both of the seal ring and the seal groove, and is subjected to surface treatment for anti-oxidation.

The seal structure for a turbocharger may further include: a housing, which accommodates a turbine impeller, and has a turbine scroll flow passage; a nozzle vane including a blade body disposed between the turbine impeller and the turbine scroll flow passage; a pair of plate members which are provided so as to be opposed to each other in a rotation axis direction of the turbine impeller with the blade body interposed therebetween; an opposing portion opposed to the plate member in a radial direction; and the seal grooves formed in the opposing portion and at a part of the plate member opposed to the opposing portion.

The housing may have an annular projecting portion, which projects between one of the plate members and the turbine impeller, and has the opposing portion formed on an outer peripheral surface thereof.

The treated portion may be an anti-oxidation film, which is formed by the surface treatment and includes a solid lubricant.

The treated portion may be formed on an inner wall surface of the seal groove, and may be a part modified by the surface treatment into a surface structure improved in oxidation resistance.

### Effects of Disclosure

According to the present disclosure, the degradation in sealability of the seal ring can be suppressed.

### BRIEF DESCRIPTION OF DRAWINGS

FIG. 1 is a schematic sectional view for illustrating a variable capacity turbocharger (turbocharger).

FIG. 2 is an exploded perspective view for illustrating a nozzle drive mechanism.

FIG. 3 is a perspective view for illustrating the nozzle drive mechanism after assembly.

FIG. 4 is an extraction view for illustrating the portion surrounded by the broken lines in FIG. 1.

FIG. 5 is an explanatory view for illustrating a first modification example.

FIG. 6 is an explanatory view for illustrating a second modification example.

FIG. 7A is an exterior view for illustrating a turbine housing of a turbocharger in a third modification example as viewed from an exhaust port side.

FIG. 7B is an exterior view for illustrating the turbine housing as viewed from a side.

FIG. 8 is a sectional view for illustrating a bearing portion and a part around the bearing portion, taken along a plane including an axial center is of a rotation shaft.

### DESCRIPTION OF EMBODIMENTS

Now, with reference to the attached drawings, an embodiment of the present disclosure is described in detail. The dimensions, materials, and other specific numerical values represented in the embodiment are merely examples used for facilitating the understanding of the invention, and do not limit the present disclosure otherwise particularly noted. Elements having substantially the same functions and configurations herein and in the drawings are denoted by the same reference symbols to omit redundant description thereof. Illustration of elements with no direct relationship to the present disclosure is omitted.

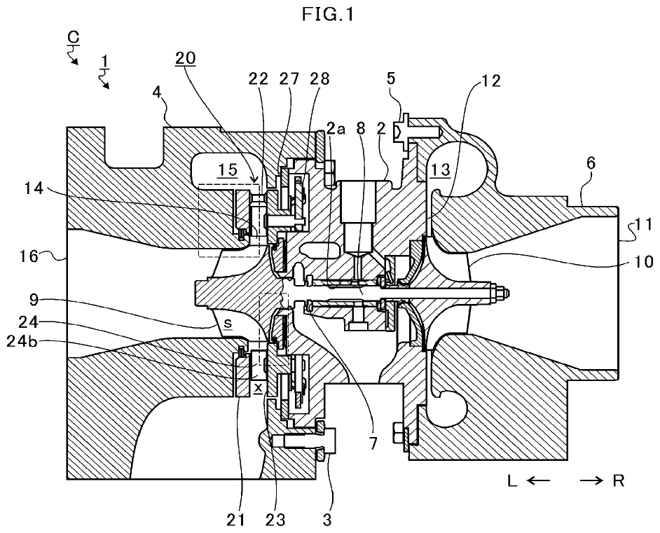

FIG. 1 is a schematic sectional view of a variable capacity turbocharger C (turbocharger). In the following description, the direction indicated by the arrow L illustrated in FIG. 1 corresponds to a left side of the variable capacity turbocharger C, and the direction indicated by the arrow R illustrated in FIG. 1 corresponds to a right side of the variable capacity turbocharger C. As illustrated in FIG. 1, the variable capacity turbocharger C includes a turbocharger main body 1. The turbocharger main body 1 includes a bearing housing 2. A turbine housing 4 is coupled to the left side of the bearing housing 2 by a fastening bolt 3. A compressor housing 6 is coupled to the right side of the bearing housing 2 by a fastening bolt 5.

The bearing housing 2 has a bearing hole 2a. The bearing hole 2a passes in a right-and-left direction of the variable capacity turbocharger C. The bearing hole 2a receives a radial bearing 7 (in this embodiment, a semi-floating bearing is illustrated in FIG. 1 as an example). A shaft 8 is axially supported by the radial bearing 7 so as to be rotatable. A turbine impeller 9 is mounted to a left end portion of the shaft 8. The turbine impeller 9 is received in the turbine housing 4 so as to be rotatable. Further, a compressor impeller 10 is mounted to a right end portion of the shaft 8. The compressor impeller 10 is received in the compressor housing 6 so as to be rotatable.

The compressor housing 6 has a suction port 11. The suction port 11 is opened on the right side of the variable capacity turbocharger C. The suction port 11 is connected to an air cleaner (not shown). Under a state in which the bearing housing 2 and the compressor housing 6 are coupled to each other by the fastening bolt 5, a diffuser flow passage 12 is formed of opposing surfaces of the bearing housing 2 and the compressor housing 6. In the diffuser flow passage 12, the air is increased in pressure. The diffuser flow passage 12 has an annular shape which extends from a radially inner side to an outer side of the shaft 8. The diffuser flow passage 12 communicates with the suction port 11 on the above-mentioned radially inner side.

The compressor housing 6 has a compressor scroll flow passage 13. The compressor scroll flow passage 13 has an annular shape. The compressor scroll flow passage 13 is positioned, for example, on the radially outer side of the shaft 8 with respect to the diffuser flow passage 12. The compressor scroll flow passage 13 communicates with a suction port of an engine (not shown). The compressor scroll flow passage 13 communicates also with the diffuser flow passage 12. Thus, when the compressor impeller 10 is rotated, air is sucked into the compressor housing 6 through the suction port 11. The sucked air is pressurized and increased in speed during a course of flowing through blades of the compressor impeller 10. The air having been pressurized and increased in speed is increased in pressure (recovered in pressure) in the diffuser flow passage 12 and the compressor scroll flow passage 13. The air increased in pressure is introduced to the suction port of the engine.

Moreover, under a state in which the bearing housing 2 and the turbine housing 4 are coupled to each other by the fastening bolt 3, a clearance 14 is defined between opposing surfaces of the bearing housing 2 and the turbine housing 4. The clearance 14 is a portion which defines a flow passage “x”, in which blade bodies 24b of nozzle vanes 24 described later are arranged and exhaust gas flows. The clearance 14 is defined in an annular shape so as to extend from the radially inner side to the outer side of the shaft 8 (turbine impeller 9).

Moreover, the turbine housing 4 has an exhaust port 16. The exhaust port 16 communicates with a turbine scroll flow passage 15 through intermediation of the turbine impeller 9. The exhaust port 16 faces a front side of the turbine impeller 9. The exhaust port 16 is connected to an exhaust gas purification device (not shown).

The turbine scroll flow passage 15 communicates with a gas inflow port (not shown) to which exhaust gas discharged from the engine is introduced. The turbine scroll flow passage 15 communicates also with the flow passage “x” described above. The flow passage “x” is connected to the turbine scroll flow passage 15 and a space “s” in which the turbine impeller 9 is disposed. The exhaust gas having been introduced from the gas inflow port to the turbine scroll flow passage 15 is introduced to the exhaust port 16 through the flow passage “x” and the turbine impeller 9 (space “s”). That is, the flow passage “x” is a flow passage extending from the turbine scroll flow passage 15 toward the turbine impeller 9. The exhaust gas causes the turbine impeller 9 to rotate in a course of flow. Then, a rotational force of the above-mentioned turbine impeller 9 is transmitted to the compressor impeller 10 through the shaft 8. The rotational force of the compressor impeller 10 causes the air to be increased in pressure and introduced to the suction port of the engine.

At this time, when a flow rate of the exhaust gas introduced to the turbine housing 4 changes, rotation amounts of the turbine impeller 9 and the compressor impeller 10 change. Depending on an operation state of the engine, in some cases, the air having been increased in pressure to a desired pressure cannot be sufficiently introduced to the suction port of the engine. Accordingly, a nozzle drive mechanism 20 is provided to the variable capacity turbocharger C.

The nozzle drive mechanism 20 is configured to change a flow passage width (nozzle throat width described later) of the flow passage “x” of the turbine housing 4. The nozzle drive mechanism 20 is configured to change a flow speed of the exhaust gas introduced to the turbine impeller 9 in accordance with a flow rate of the exhaust gas. Specifically, when a rotation number of the engine is small, and a flow rate of the exhaust gas is small, the nozzle drive mechanism 20 reduces a nozzle opening degree of the flow passage “x” to increase the flow speed of the exhaust gas introduced to the turbine impeller 9. In such a manner, the nozzle drive mechanism 20 is capable of causing the turbine impeller 9 to rotate even with a small flow rate. A configuration of the nozzle drive mechanism 20 is described below.

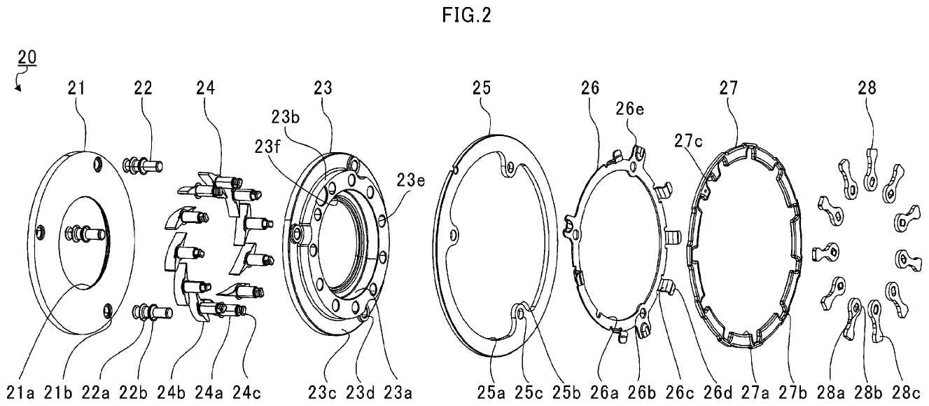

FIG. 2 is an exploded perspective view for illustrating the nozzle drive mechanism 20. As illustrated in FIG. 2, the nozzle drive mechanism 20 includes a plate 21 (plate member). The plate 21 has a plate axial hole 21a. The plate axial hole 21a passes through the plate 21 in an axial direction of the shaft 8 (rotation axis direction of the turbine impeller 9, hereinafter simply referred to as “axial direction”). The plate 21 has, for example, a flat plate shape with a circular shape in a cross section perpendicular to the axial direction. The plate 21 has, on an outer peripheral surface side thereof, plate pin holes 21b. The plate pin holes 21b pass through the plate 21 in the axial direction.

A plurality of (three in this case) pin holes 21b are formed apart from each other in a circumferential direction of the plate 21. One ends of pins 22 are inserted through the plate pin holes 21b, respectively.

A nozzle ring 23 (plate member) is located on the compression impeller 10 side with respect to the plate 21 (right side in FIG. 1). The plate 21 is located on a side opposite to the compressor impeller 10 and the radial bearing 7 with respect to the nozzle ring 23 (exhaust port 16 side). The nozzle ring 23 includes a main body portion 23b having an annular shape. The main body portion 23b has an insertion hole 23a. The insertion hole 23a passes through the main body portion 23b in the axial direction. A flange portion 23c having an annular shape is formed on the plate 21 side of the main body portion 23b. The flange portion 23c projects from the main body portion 23b toward the radially outer side. The flange portion 23c has ring pin holes 23d formed at portions opposed to the plate pin holes 21b of the plate 21. The ring pin holes 23d pass through the flange portion 23c in the axial direction. The pins 22 are inserted through the ring pin holes 23d.

The pins 22 each have a first annular projection 22a. The first annular projection 22a projects in the radial direction. An outer diameter of the first annular projection 22a is larger than an inner diameter of the plate pin hole 21b. When the pin 22 is inserted through the plate pin hole 21b, the first annular projection 22a is brought into abutment against an opposing surface of the plate 21 with respect to the nozzle ring 23. In such a manner, an insertion position of the pin 22 with respect to the plate pin hole 21b is determined.

Similarly, the pins 22 each have a second annular projection 22b. The second annular projection 22b projects in the radial direction. The second annular projection 22b is located on another end side with respect to the first annular projection 22a. An outer diameter of the second annular projection 22b is larger than an inner diameter of the ring pin hole 23d. Therefore, when the pin 22 is inserted through the ring pin hole 23d, the second annular projection 22b is brought into abutment against an opposing surface of the nozzle ring 23 with respect to the plate 21. In such a manner, an insertion position of the pin 22 with respect to the ring pin hole 23d is determined.

As described above, an opposing distance between the plate 21 and the nozzle ring 23 is determined by the pins 22. The flow passage “x” described above is defined by the clearance between the plate 21 and the nozzle ring 23 opposed to each other. A length of the flow passage “x” in the axial direction is determined by the pins 22. The plate 21 and the nozzle ring 23 are opposed to each other in the axial direction with the blade bodies 24b of the nozzle vanes 24 being interposed therebetween.

Moreover, the main body portion 23b has shaft-portion holes 23e. The shaft-portion holes 23e pass through the main body portion 23b in the axial direction. A plurality of (eleven in this case) shaft-portion holes 23e are formed apart from each other in the circumferential direction of the main body portion 23b.

Similarly to the shaft-portion holes 23e, a plurality of (eleven in this case) nozzle vanes 24 are provided apart from each other in the circumferential direction of the main body portion 23b (rotation direction of the turbine impeller 9). The blade bodies 24b are located in the clearance between the plate 21 and the nozzle ring 23 (that is, the flow passage “x”). Shaft portions 24a projecting from the blade bodies 24b toward the nozzle ring 23 side are inserted through the shaft-portion holes 23e and axially supported therein (in a cantilever state). The nozzle vanes 24 are supported on the nozzle ring 23. In this case, the description has been made of the case in which the shaft portions 24a are axially supported by the nozzle ring 23. However, the shaft portions 24a may extend also toward the plate 21 side, and the plate 21 may have holes for axially supporting the shaft portions 24a.

A support ring 25 is an annular member. The support ring 25 has a support axial hole 25a. The main body portion 23b of the nozzle ring 23 is inserted through the support axial hole 25a. Projection portions 25b projecting toward the radially inner side are formed on an inner peripheral surface of the support axial hole 25a. A plurality of (three in this case) projection portions 25b are formed so as to match with the ring pin holes 23d. The projection portions 25b each have a support pin hole 25c. The support pin holes 25c are formed at positions opposed to the ring pin holes 23d. The support pin holes 25c pass through the projection portions 25b, respectively, in the axial direction.

A drive ring support 26 is an annular member. The drive ring support 26 is located on a side opposite to the flange portion 23c of the nozzle ring 23 with respect to the support ring 25 (on a side opposite to the plate 21 with respect to the nozzle vanes 24). Similarly to the support ring 25, the drive ring support 26 has a drive support axial hole 26a. The main body portion 23b of the nozzle ring 23 is inserted through the drive support axial hole 26a from the left side in FIG. 2 (plate 21 side). Moreover, the drive ring support 26 has drive support pin holes 26b. The drive support pin holes 26b are formed at positions opposed to the support pin holes 25c. The drive support pin holes 26b pass through the drive ring support 26 in the axial direction.

Locking portions 26c are formed on an outer periphery of the drive ring support 26. The locking portions 26c project in the axial direction toward the right side in FIG. 2 (side away from the support ring 25). A bent portion 26d is formed at a distal end of each of the locking portions 26c. The bent portions 26d are bent toward the radially outer side of the drive ring support 26. Moreover, support projecting portions 26e are formed on an outer periphery of the drive ring support 26. The support projecting portions 26e project toward the radially outer side. The support projecting portions 26e are arranged at positions different from the positions of the locking portions 26c in the circumferential direction.

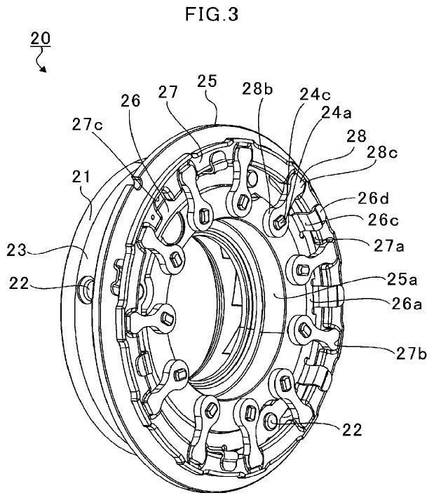

FIG. 3 is a perspective view for illustrating the nozzle drive mechanism 20 after assembly. As illustrated in FIG. 2 or FIG. 3, the pins 22 are inserted through the plate pin holes 21b, the ring pin holes 23d, the support pin holes 25c, and the drive support pin holes 26b, and both ends of each pin 22 are caulked. In such a manner, as illustrated in FIG. 3, the plate 21, the nozzle ring 23, the support ring 25, and the drive ring support 26 are assembled to each other.

A drive ring 27 is an annular member. The drive ring 27 has a drive axial hole 27a. The drive axial hole 27a passes through the drive ring 27 in the axial direction. An inner diameter of the drive axial hole 27a is larger than the locking portions 26c of the drive ring support 26. In an assembled state of the nozzle drive mechanism 20, the locking portions 26c of the drive ring support 26 are located on an inner side of the drive axial hole 27a. At this time, the bent portions 26d are located on the right side in FIG. 2 with respect to the drive ring 27. The drive ring 27 is sandwiched between the bent portions 26d and the support projecting portions 26e. The drive ring 27 is supported on the locking portions 26c from the radially inner side.

Distal end portions 24c of the shaft portions 24a of the nozzle vanes 24 project from the shaft-portion holes 23e of the nozzle ring 23, respectively. The distal end portions 24c of the shaft portions 24a are fitted to plate holes 28a of link plates 28 described later, respectively.

The number of the link plates 28 is the same as the number of the nozzle vanes 24. The plurality of link plates 28 each include a main body 28b. The main body 28b has the plate hole 28a (see FIG. 2). The distal end portion 24c of the shaft portion 24a is inserted through the plate hole 28a. The nozzle ring 23 is disposed between the blade bodies 24b of the nozzle vanes 24 and the main bodies 28b of the link plates 28.

The main body 28b of the link plate 28 is disposed in the drive axial hole 27a of the drive ring 27. The link plate 28 has a link projection 28c. The link projection 28c projects radially outward from the main body 28b toward an inner peripheral surface of the drive axial hole 27a.

Fitting grooves 27b are formed in an inner periphery of the drive axial hole 27a of the drive ring 27. The fitting grooves 27b are recessed toward the radially outer side. The fitting grooves 27b are formed apart from each other in the circumferential direction of the drive axial hole 27a, and the number of the fitting grooves 27b is the same as the number of the nozzle vanes 24. The link projections 28c are fitted to the fitting grooves 27b, respectively. The distal end portion 24c of the shaft portion 24a inserted through the plate hole 28a of the main body 28b is caulked on the link plate 28. The link plate 28 and the shaft portion 24a integrally rotate.

The drive ring 27 has a drive groove 27c at one position on an inner periphery of the drive axial hole 27a. The drive groove 27c has approximately the same shape as the fitting groove 27b. The drive groove 27c is different in position in the circumferential direction from the fitting groove 27b. A drive link (not shown) is fitted to the drive groove 27c. The drive link has approximately the same shape as the link plate 28. Motive power of an actuator (not shown) is transmitted to the drive ring 27 through the drive link. As a result, the drive ring 27 rotates (slides) while being supported by the locking portions 26c of the drive ring support 26.

When the drive ring 27 rotates, the link projections 28c fitted to the fitting grooves 27b are pressed by the drive ring 27 in a rotation direction. The link plate 28 rotates (swings) about an axial center of the shaft portion 24a. As a result, the shaft portions 24a mounted to the link plates 28 rotate. The blade bodies 24b of the plurality of nozzle vanes 24 synchronously rotate together with the shaft portions 24a. In such a manner, a flow passage width of the blade bodies 24b adjacent to each other in the flow passage “x” (so-called nozzle throat width) changes. That is, opening degrees of the nozzle vanes 24 change. A flow passage area of the flow passage “x” defined by the adjacent blade bodies 24b, the plate 21, and the nozzle ring 23 changes.

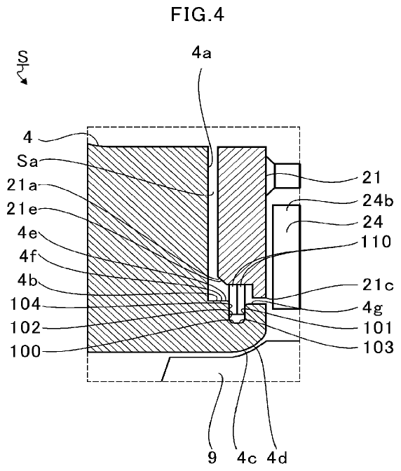

FIG. 4 is an extraction view of the portion surrounded by the broken lines in FIG. 1. As illustrated in FIG. 4, the variable capacity turbocharger C has a seal structure S. The seal structure S includes the turbine housing 4, the plate 21, and seal rings 110.

The plate axial hole 21a of the plate 21 has a plate projecting portion 21c. The plate projecting portion 21c projects from an inner peripheral surface of the plate axial hole 21a toward the radially inner side. A surface of the plate 21 on the nozzle vane 24 side is flush with the plate projecting portion 21c. A side surface of the plate projecting portion 21c may be perpendicular to the axial direction or may be inclined with respect to the axial direction.

The plate axial hole 21a has a chamfered portion 21e. The chamfered portion 21e is located at an end portion of the plate axial hole 21a on a side opposite to the blade bodies 24b (left side in FIG. 4, a side opposite to the plate projecting portion 21c). The chamfered portion 21e is inclined toward the radially inner side as approaching the blade bodies 24b. Here, the description has been made of the case in which the plate axial hole 21a has the chamfered portion 21e. However, the chamfered portion 21e is not an essentially required configuration. Moreover, a shape of the chamfered portion 21e in a cross section taken along a plane including a center axis of the shaft 8 (for example, the cross section illustrated in FIG. 4) may be linear as illustrated in FIG. 4 or may be curved.

An opposing wall portion 4a is a part of the turbine housing 4 which is opposed to the plate 21 in the axial direction. The opposing wall portion 4a is located on a side opposite to the blade bodies 24b with respect to the plate 21 (left side in FIG. 4, a side opposite to the bearing housing 2). A clearance Sa in the axial direction is defined between the opposing wall portion 4a and the plate 21.

The opposing wall portion 4a has, on a radially inner side thereof, a turbine projecting portion 4b (projecting portion). The turbine projecting portion 4b has an annular shape. The turbine projecting portion 4b projects toward the plate 21 side. The turbine projecting portion 4b has a turbine hole 4c. The turbine hole 4c passes through the turbine projecting portion 4b in the axial direction. An inner peripheral surface of the turbine hole 4c has a shroud portion 4d. The shroud portion 4d is opposed to the turbine impeller 9 with a clearance in the radial direction.

The turbine impeller 9 and the turbine projecting portion 4b are inserted through the plate axial hole 21a of the plate 21. The turbine projecting portion 4b is opposed to the plate 21 from the radially inner side. The turbine projecting portion 4b is located between the plate 21 and the turbine impeller 9.

An outer peripheral surface of the turbine projecting portion 4b has an opposing portion 4e. The opposing portion 4e is opposed to the inner peripheral surface of the plate axial hole 21a of the plate 21 in the radial direction. The opposing portion 4e has a seal groove 100. The seal groove 100 extends from the outer peripheral surface of the opposing portion 4e (turbine projecting portion 4b) toward the radially inner side of the plate 21 (shaft 8). A large-diameter portion 4f is a part of the turbine projecting portion 4b on the opposing wall portion 4a side with respect to the seal groove 100 (left side in FIG. 4, a base end side of the turbine projecting portion 4b). A small-diameter portion 4g is a part of the turbine projecting portion 4b on the blade bodies 24b side with respect to the seal groove 100 (right side in FIG. 4, a distal end side of the turbine projecting portion 4b). An outer diameter of the large-diameter portion 4f is larger than an outer diameter of the small-diameter portion 4g. However, it is not always required that the turbine projecting portion 4b have a difference in outer diameter as given between the large-diameter portion 4f and the small-diameter portion 4g. Outer diameters of the turbine projecting portion 4b on the base end side and the distal end side over the seal groove 100 may be equal to each other.

An inner wall surface of the seal groove 100 includes an inner surface 101, an inner surface 102, and a bottom surface 103. The inner surface 101 is a part of the inner wall surface of the seal groove 100 on the blade bodies 24b side (right side in FIG. 4, a distal end side of the turbine projecting portion 4b). The inner surface 102 is a part of the inner wall surface of the seal groove 100 on the opposing wall portion 4a side (left side in FIG. 4, a base end side of the turbine projecting portion 4b). The inner surface 101 and the inner surface 102 extend in the radial direction of the plate 21 (shaft 8). The inner surface 102 extends toward the radially outer side more than the inner surface 101. However, the inner surface 102 and the inner surface 101 may extend to the same position on the radially outer side. The bottom surface 103 extends in parallel to the axial direction.

The seal rings 110 are disposed in the seal groove 100. The seal rings 110 each have an annular shape. However, the seal rings 110 may each be partially cut out. Two seal rings 110 are laminated in the axial direction. However, one seal ring 110 may be provided, or three or more seal rings 110 may be laminated.

Inner peripheral surfaces of the seal rings 110 are located inside the seal groove 100. A clearance is defined between the inner peripheral surfaces of the seal rings 110 and the bottom surface 103 of the seal groove 100. Outer peripheral surfaces of the seal rings 110 are held in abutment against (pressed against) a part of the inner peripheral surface of the plate axial hole 21a of the plate 21 between the plate projecting portion 21c and the chamfered portion 21e. The seal rings 110 are inserted into the plate axial hole 21a. The seal rings 110 are pressurized toward the radially inner side by the plate axial hole 21a. The seal rings 110 are pressurized by the plate axial hole 21a so as to be reduced in diameter within a range of elastic deformation.

For example, when the plate 21 is thermally expanded, the seal rings 110 follow the thermal expansion to extend toward the radially outer side. However, there is a case in which, for example, the inner wall surface of the seal groove 100 (inner surface 101 and inner surface 102) is expanded by oxidation due to aging degradation. In this case, there is a risk in that the seal rings 110 are pressed by the inner surface 101 and the inner surface 102, with the result that deformation of the seal rings 110 in the radial direction is hindered by friction. Accordingly, a treated portion 104 is formed on the seal groove 100.

The treated portion 104 is a part having been subjected to surface treatment for anti-oxidation. The treated portion 104 is formed on the entirety of the inner wall surface of the seal groove 100. That is, the treated portion 104 is formed on each of the inner surface 101, the inner surface 102, and the bottom surface 103. However, it is only required that the treated portion 104 be formed at least partially on the inner surface 101 and the inner surface 102.

The treated portion 104 suppresses oxidation of the inner wall surface of the seal groove 100. Therefore, the deformation of the seal rings 110 in the radial direction is less liable to be hindered. As a result, for example, when the plate 21 is thermally expanded, the seal rings 110 can follow the thermal expansion to extend toward the radially outer side. The degradation in sealability is suppressed.

The treated portion 104 may be an anti-oxidation film which includes a solid lubricant and is formed by the surface treatment. The treated portion 104 includes the solid lubricant, and hence the seal rings 110 easily slide in the axial direction. However, it is not always required that the treated portion 104 include the solid lubricant. Examples of the solid lubricant include mica (natural mineral silicate), molybdenum disulfide, graphite, and PTFE. Moreover, the treated portion 104 may be a part modified by the surface treatment into a surface structure which is improved in oxidation resistance.

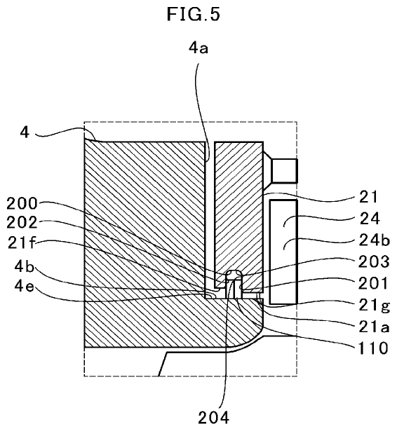

FIG. 5 is an explanatory view for illustrating a first modification example. FIG. 5 is an illustration of a part corresponding to FIG. 4 in the first modification example in an extracted manner. In the above-mentioned embodiment, the description has been made of the case in which the turbine housing 4 has the seal groove 100. In the first modification example, as illustrated in FIG. 5, a seal groove 200 is formed in the inner peripheral surface of the plate axial hole 21a of the plate 21. The seal groove 200 extends from the inner peripheral surface of the plate axial hole 21a toward the radially outer side of the plate 21.

A large-inner-diameter portion 21f is a part of the plate axial hole 21a on the opposing wall portion 4a side with respect to the seal groove 200 (left side in FIG. 5, a base end side of the turbine projecting portion 4b). A small-inner-diameter portion 21g is a part of the plate axial hole 21a on the blade bodies 24b side with respect to the seal groove 200 (right side in FIG. 5, a distal end side of the turbine projecting portion 4b). An inner diameter of the large-inner-diameter portion 21f is larger than an inner diameter of the small-inner-diameter portion 21g. However, positions of the large-inner-diameter portion 21f and the small-inner-diameter portion 21g may be switched. Moreover, it is not always required that the plate axial hole 21a have a difference in inner diameter as given between the large-inner-diameter portion 21f and the small-inner-diameter portion 21g. Inner diameters of the plate axial hole 21a on both sides over the seal groove 200 may be equal to each other.

The outer peripheral surfaces of the seal rings 110 are located inside the seal groove 200. A clearance is defined between the outer peripheral surfaces of the seal rings 110 and a bottom surface 203 of the seal groove 200. The outer peripheral surfaces of the seal rings 110 are held in abutment against (pressed against) the outer peripheral surface of the turbine projecting portion 4b, that is, the opposing portion 4e. The turbine projecting portion 4b is inserted into the seal rings 110. The seal rings 110 are pressurized toward the radially outer side by the turbine projecting portion 4b. The seal rings 110 are pressurized by the turbine projecting portion 4b so as to be increased in diameter within a range of elastic deformation.

For example, when the turbine projecting portion 4b contracts at the time of cooling, the seal rings 110 follow the contraction to contract toward the radially inner side. However, for example, when an inner wall surface of the seal groove 200 (inner surface 201 and inner surface 202) is expanded by oxidation due to aging degradation, as described in the embodiment described above, there is a risk in that the deformation of the seal rings 110 in the radial direction is hindered. Accordingly, a treated portion 204 is formed on the seal groove 200.

The treated portion 204 is a part having been subjected to the surface treatment for anti-oxidation. The treated portion 204 is formed on the entirety of the inner wall surface of the seal groove 200. That is, the treated portion 204 is formed on each of the inner surface 201, the inner surface 202, and the bottom surface 203. However, it is only required that the treated portion 204 be formed at least partially on the inner surface 201 and the inner surface 202. Similarly to the embodiment described above, the treated portion 204 suppresses oxidation of the inner wall surface of the seal groove 200. Therefore, the degradation in sealability is suppressed.

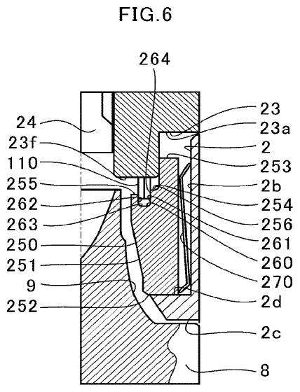

FIG. 6 is an explanatory view for illustrating a second modification example. FIG. 6 is an illustration of a part corresponding to the portion surrounded by one-dot chain lines in FIG. 1 in the second modification example in an extracted manner. As illustrated in FIG. 6, in the second modification example, a heat barrier plate 250 has a seal groove 260.

In the bearing housing 2, an opposing wall portion 2b opposed to the turbine impeller 9 has an insertion hole 2c. The shaft 8 is inserted through the insertion hole 2c. The opposing wall portion 2b has an annular portion 2d. The annular portion 2d projects from the opposing wall portion 2b toward the turbine impeller 9 side. The insertion hole 2c is opened in the annular portion 2d.

A main body portion 251 of the heat barrier plate 250 is, for example, a plate member. The main body portion 251 is disposed between the opposing wall portion 2b of the bearing housing 2 and the turbine impeller 9. The main body portion 251 has a through hole 252. The annular portion 2d is inserted through the through hole 252.

A radially outer projection 253 is formed on the opposing wall portion 2b side (right side in FIG. 6, a side opposite to the turbine impeller 9) of the outer peripheral surface of the main body portion 251. The radially outer projection 253 projects from the outer peripheral surface of the main body portion 251 toward the radially outer side.

The insertion hole 23a of the nozzle ring 23 has a radially inner projection 23f. The radially inner projection 23f projects from the blade bodies 24b side of the inner peripheral surface of the insertion hole 23a (left side in FIG. 6, the plate 21 side) toward the radially inner side. The heat barrier plate 250 is located inside the insertion hole 23a of the nozzle ring 23. The radially outer projection 253 of the heat barrier plate 250 is held in abutment against the radially inner projection 23f of the nozzle ring 23 from the opposing wall portion 2b side.

A spring member 270 is disposed between the opposing wall portion 2b and the heat barrier plate 250. A radially outer end of the spring member 270 is held in abutment against the radially outer projection 253. A radially inner end of the spring member 270 is held in abutment against the opposing wall portion 2b. The heat barrier plate 250 is pressed by the spring member 270 toward the nozzle ring 23 side.

The main body portion 251 is opposed to the radially inner projection 23f from the radially inner side. An opposing portion 254 is formed on the turbine impeller 9 side of the outer peripheral surface of the main body portion 251 with respect to the radially outer projection 253 (left side in FIG. 6, the plate 21 side). The opposing portion 254 is opposed to the inner peripheral surface of the radially inner projection 23f in the radial direction. The opposing portion 254 has a seal groove 260. The seal groove 260 is located on the radially inner side with respect to the radially inner projection 23f. A small-diameter portion 255 is a part of the opposing portion 254 on the turbine impeller 9 side with respect to the seal groove 260. A large-diameter portion 256 is a part of the opposing portion 254 between the seal groove 260 and the radially outer projection 253. An outer diameter of the small-diameter portion 255 is smaller than an outer diameter of the large-diameter portion 256.

The seal rings 110 are disposed in the seal groove 260. The inner peripheral surfaces of the seal rings 110 are located inside the seal groove 260. A clearance is defined between the inner peripheral surfaces of the seal rings 110 and the bottom surface 263 of the seal groove 260. The outer peripheral surfaces of the seal rings 110 are held in abutment against (pressed against) the radially inner projection 23f of the nozzle ring 23. The seal rings 110 are inserted on an inner side of the radially inner projection 23f. The seal rings 110 are pressurized by the radially inner projection 23f toward the radially inner side. The seal rings 110 are pressurized by the radially inner projection 23f so as to be reduced in diameter within a range of elastic deformation.

For example, when the nozzle ring 23 is thermally expanded, the seal rings 110 follow the thermal expansion to extend toward the radially outer side. However, for example, when the inner wall surface of the seal groove 260 (inner surface 261 and inner surface 262) is expanded by oxidation due to aging degradation, as described in the embodiment described above, there is a risk in that the deformation of the seal rings 110 in the radial direction is hindered. Accordingly, a treated portion 264 is formed on the seal groove 260.

The treated portion 264 is a part having been subjected to the surface treatment for anti-oxidation. The treated portion 264 is formed on the entirety of the inner wall surface of the seal groove 260. That is, the treated portion 264 is formed on each of the inner surface 261, the inner surface 262, and the bottom surface 263. However, it is only required that the treated portion 264 be formed at least partially on the inner surface 261 and the inner surface 262. Similarly to the embodiment described above, the treated portion 264 suppresses oxidation of the inner wall surface of the seal groove 260. Therefore, the degradation in sealability is suppressed.

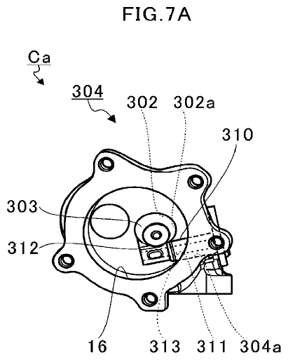

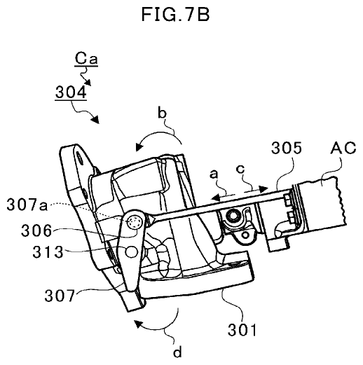

FIG. 7A is an exterior view for illustrating a turbine housing 304 of a turbocharger Ca in a third modification example as viewed from the exhaust port 16 side. FIG. 7B is an exterior view for illustrating the turbine housing 304 as viewed from a side. The turbine housing 304 has, inside thereof, a flow passage communicating a gas inflow port 301, to which the exhaust gas is introduced, and the turbine scroll flow passage 15. A bypass flow passage 302 has one end communicating with the flow passage on upstream of the turbine scroll flow passage 15. The bypass flow passage 302 communicates with the exhaust port 16 without intermediation of the turbine scroll flow passage 15. A valve 303 is configured to open and close an outlet end 302a of the bypass flow passage 302. When the valve 303 is opened, a part of the exhaust gas having flowed in through the gas inflow port 301 flows around the turbine impeller 9 through the bypass flow passage 302 and then is discharged through the exhaust port 16.

As illustrated in FIG. 7B, an actuator rod 305 is disposed outside the turbine housing 304. The actuator rod 305 has one end mounted to an actuator AC. The actuator rod 305 is actuated by motive power of the actuator AC in directions indicated by the arrow “a” and the arrow “c” (approximately axial direction). The actuator rod 305 has another end having a pin rod 306 mounted thereto. The pin rod 306 projects in a direction orthogonal to the axial direction.

A link portion 307 is a plate member. The link portion 307 is provided outside the turbine housing 304. The link portion 307 has one end having a link hole 307a. The pin rod 306 is inserted through the link hole 307a of the link portion 307 so as to be rotatable. When the actuator rod 305 is actuated to move in the direction indicated by the arrow “a”, the link portion 307 swings in the direction indicated by the arrow “b” in FIG. 7B. When the actuator rod 305 is actuated to move in the direction indicated by the arrow “c”, the link portion 307 swings in the direction indicated by the arrow “d” in FIG. 7B.

The turbine housing 304 has a housing hole 304a. The housing hole 304a passes through an outside of the turbine housing 304 and a downstream side of the turbine impeller 9 inside the turbine housing 304. A bearing portion 310 is inserted through the housing hole 304a. The bearing portion 310 is a cylindrical member. The bearing portion 310 has a bearing hole 311. A rotation shaft 313 is inserted through the bearing hole 311. Moreover, the bearing portion 310 projects inside and outside the turbine housing 304. The rotation shaft 313 is axially supported in the bearing hole 311 so as to be rotatable. The rotation shaft 313 has one end projecting from the bearing hole 311 toward an inner side of the turbine housing 304. The rotation shaft 313 has another end projecting from the bearing hole 311 toward an outer side of the turbine housing 304. The another end of the rotation shaft 313 is mounted to the link portion 307.

A mounting plate 312 is a plate member. The valve 303 is provided on one end side of the mounting plate 312. The rotation shaft 313 is mounted on another end side of the mounting plate 312. The mounting plate 312 is configured to couple the valve 303 and the rotation shaft 313 to each other. The valve 303 and the rotation shaft 313 integrally rotate in a rotation direction of the rotation shaft 313. When the actuator rod 305 is actuated, the link portion 307 swings about an axial center of the rotation shaft 313 as a rotation center (directions indicated by the arrow “b” and the arrow “d” in FIG. 7B). The rotation shaft 313 rotates accompanied with the swing of the link portion 307. With the rotation of the rotation shaft 313, the valve 303 opens and closes the outlet end 302a of the bypass flow passage 302.

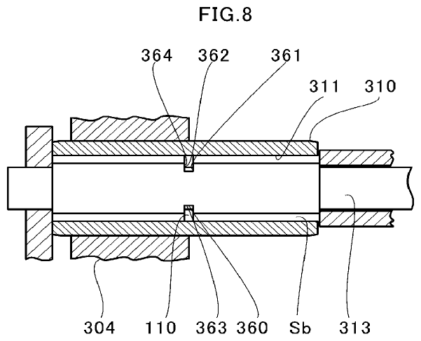

FIG. 8 is a sectional view for illustrating the bearing portion 310 and a part around the bearing portion 310, taken along a plane including the axial center of the rotation shaft 313. As illustrated in FIG. 8, one end of the bearing portion 310 is located inside the turbine housing 304 (left side of the turbine housing 304 in FIG. 8). Another end of the bearing portion 310 is located outside the turbine housing 304 (right side of the turbine housing 304 in FIG. 8). A clearance Sb is defined between the inner peripheral surface of the bearing hole 311 of the bearing portion 310 and the outer peripheral surface of the rotation shaft 313.

There is a case in which the exhaust gas flows into the clearance Sb of the bearing hole 311 due to a pressure difference between an inside and an outside of the turbine housing 304. Accordingly, the seal ring 110 is disposed inside the bearing portion 310. The outer peripheral surface of the rotation shaft 313 has a seal groove 360. The seal groove 360 is located inside the bearing hole 311.

The seal ring 110 is disposed in the seal groove 360. The inner peripheral surface of the seal ring 110 is located inside the seal groove 360. A clearance is defined between the inner peripheral surface of the seal ring 110 and a bottom surface 363 of the seal groove 360. The outer peripheral surface of the seal ring 110 is held in abutment against (pressed against) the inner peripheral surface of the bearing hole 311. The seal ring 110 is inserted into the bearing hole 311. The seal ring 110 is pressurized toward the radially inner side by the inner peripheral surface of the bearing hole 311. The seal ring 110 is pressurized by the inner peripheral surface of the bearing hole 311 so as to be reduced in diameter within a range of elastic deformation.

For example, when the bearing hole 311 is thermally expanded, the seal ring 110 follows the thermal expansion to extend toward the radially outer side. However, for example, when the inner wall surface of the seal groove 360 (inner surface 361 and inner surface 362) is expanded by oxidation due to aging degradation, as described in the embodiment described above, there is a risk in that the deformation of the seal ring 110 in the radial direction is hindered. Accordingly, a treated portion 364 is formed on the seal groove 360.

The treated portion 364 is a part having been subjected to the surface treatment for anti-oxidation. The treated portion 364 is formed on the entirety of the inner wall surface of the seal groove 360. That is, the treated portion 364 is formed on each of the inner surface 361, the inner surface 362, and the bottom surface 363. However, it is only required that the treated portion 364 be formed at least partially on the inner surface 361 and the inner surface 362. Similarly to the embodiment described above, the treated portion 364 suppresses oxidation of the inner wall surface of the seal groove 360. Therefore, the degradation in sealability is suppressed.

The embodiment of the present disclosure has been described above with reference to the attached drawings, but, needless to say, the present disclosure is not limited to the above-mentioned embodiment. It is apparent that those skilled in the art may arrive at various alternations and modifications within the scope of claims, and those examples are construed as naturally falling within the technical scope of the present disclosure.

For example, in the embodiment and the modification examples described above, the description has been made of the case in which the treated portion 104, 204, 264, 364 is formed on the seal groove 100, 200, 260, 360. However, the treated portion 104, 204, 264, 364 may be formed on the seal ring 110. For example, when the treated portion 104, 204, 264, 364 is an anti-oxidation film, the anti-oxidation film is transferred from the seal ring 110 to the seal groove 100, 200, 260, 360. As a result, similarly to the embodiment and the modification examples described above, the degradation in sealability is suppressed.

Moreover, in the embodiment and the modification examples described above, the description has been made of the case in which the treated portion 104, 204, 264, 364 is an anti-oxidation film including a solid lubricant. However, the treated portion 104, 204, 264, 364 may be formed on the inner wall surface of the seal groove 100, 200, 260, 360 and may be a part modified by the surface treatment into a surface structure which is improved in oxidation resistance.

Moreover, the seal groove and the seal ring may be provided at a position in the turbocharger other than the positions described in the embodiment and the modification examples described above.

Moreover, any two or three or all four of the seal grooves 100, 200, 260, and 360 may be formed, and the seal ring 110 may be disposed in each of the seal grooves. The treated portions 104, 204, 264, and 364 corresponding to the seal grooves 100, 200, 260, and 360 or the seal ring 110 may be formed.

Moreover, as in the third modification example described above, when the seal groove, the seal ring, and the treated portion are provided at portions not related to the nozzle drive mechanism 20, the nozzle drive mechanism 20 is not an essentially required configuration.

### INDUSTRIAL APPLICABILITY

The present disclosure can be used for a seal structure for a turbocharger in which a seal ring is disposed in a seal groove.

What is claimed is:

1. A seal structure for a turbocharger, comprising:
a seal ring;
a seal groove in which the seal ring is disposed; and
a treated portion, which is formed at least at a part of one or both of the seal ring and the seal groove, and is subjected to surface treatment for anti-oxidation.

2. The seal structure for a turbocharger according to claim 1, further comprising:
a housing, which accommodates a turbine impeller, and has a turbine scroll flow passage;
a nozzle vane including a blade body, which is disposed between the turbine impeller and the turbine scroll flow passage;
a pair of plate members which are provided so as to be opposed to each other in a rotation axis direction of the turbine impeller with the blade body interposed therebetween;
an opposing portion opposed to the plate member in a radial direction; and
the seal grooves formed in the opposing portion and at a part of the plate member opposed to the opposing portion.

3. The seal structure for a turbocharger according to claim 2, wherein the housing has an annular projecting portion, which projects between one of the plate members and the turbine impeller, and has the opposing portion formed on an outer peripheral surface thereof.

4. The seal structure for a turbocharger according to claim 1, wherein the treated portion is an anti-oxidation film, which is formed by the surface treatment and includes a solid lubricant.

5. The seal structure for a turbocharger according to claim 2, wherein the treated portion is an anti-oxidation film, which is formed by the surface treatment and includes a solid lubricant.

6. The seal structure for a turbocharger according to claim 3, wherein the treated portion is an anti-oxidation film, which is formed by the surface treatment and includes a solid lubricant.

7. The seal structure for a turbocharger according to claim 1, wherein the treated portion is formed on an inner wall surface of the seal groove, and is a part modified by the surface treatment into a surface structure improved in oxidation resistance.

8. The seal structure for a turbocharger according to claim 2, wherein the treated portion is formed on an inner wall surface of the seal groove, and is a part modified by the surface treatment into a surface structure improved in oxidation resistance.

9. The seal structure for a turbocharger according to claim 3, wherein the treated portion is formed on an inner wall surface of the seal groove, and is a part modified by the surface treatment into a surface structure improved in oxidation resistance.
